(19) United States
(12) Patent Application Publication
(10) Pub. No.: US 2011/0228278 A1
(43) Pub. Date: Sep. 22, 2011

(54) UV-VIS ATR SHORT PATHLENGTH SPECTROSCOPY OF PRINTING INKS

(76) Inventors: Kathryn Lee, Basking Ridge, NJ (US); Danny Clark Rich, Hamilton Square, NJ (US)

(21) Appl. No.: 13/128,247

(22) PCT Filed: Nov. 12, 2009
(86) PCT No.: PCT/US09/06098

§ 371 Date: May 26, 2011

Related U.S. Application Data
(60) Provisional application No. 61/113,265, filed on Nov. 11, 2008.

(51) Int. Cl. G01N 21/55

(52) U.S. Cl. 356/445

(57) ABSTRACT

A spectroanalytic system and process for analyzing the absorption properties of highly absorbing viscous materials is disclosed. The measurement probe includes a UV-VIS optical system. A single crystal is shaped so that the light enters the crystal perpendicular to its surface and is Incident on the back face at an angle of 45 degree or greater and the reflected light is collected and channeled to a detector system. This system provides an attenuated total reflectance measurement with minimal reflection points wherein the total path length is comparable with a typically printed offset ink film (0.7-1.3 micron). The total absorption process path length depends only on the refractive index of the chosen crystal and on the angle of incidence of the single reflection. High refractive index materials, like diamond, have path lengths of 50 nm, and an economical material such as cubic zirconium provides a path length of 0.1 micron.

### CROSS REFERENCE TO RELATED APPLICATIONS

This application claims priority to U.S. Provisional Patent Application No. 61/113,265, filed on Nov. 2, 2008, which is hereby incorporated herein by reference.

### BACKGROUND OF THE INVENTION

Conventional methods for the assessment of the absorption and color strength of pigments, dispersions, flushes, inks and paints require the use of a dilution of a sample of such preparations using either a clear varnish or a white pigmented varnish. Such a diluent is commonly known as a “bleach.”

However, the dilution of strongly optically absorbing materials is often fraught with potential errors. As such materials are highly absorbing, small errors in weighing, dispensing and mixing the combination will result in significant errors in optical absorbance. Additionally, it has been reported that mixing a concentrated dispersion of strongly absorbing particles into a large volume of clear or white media may adversely affect the stability of the dispersion. Dispersions of solid particles constitute a state of matter in unstable equilibrium. The surface forces repelling the particles, to keep them separate, are balanced with the surface forces that push the particles together. A sudden dilution of the highly concentrated pigmented ink can shock the dispersion and break the balance of forces. As a result the pigment particles may either agglomerate, aggregate, flood or float. In agglomeration, the attractive forces pull the pigment particles together into a tight ball and sink in the carrier fluid. If the forces are not so strong then the process of pigment attraction is known as flocculation. In contrast, if the repulsive forces dominate, then the pigment particles will be displaced upward in the carrier fluid in process known as flooding or floating. All of these actions will directly impact upon the absorption measurement introducing errors into the measurement process.

Additionally, in the case of paste inks that have been diluted with resin, they do not set immediately. These paste inks will easily transfer to the surface of a color measurement system, permanently contaminating the measurement aperture. Thus, spectral analysis of such inks must be done in a closed cell or with an air gap between the surface of the mixture and the measurement port of the instrument. These are known sources of error in spectral reflectance or spectral transmittance measurements. In transmittance, there will be some loss of contact between the cell window and the ink which produces a light channeling and reduces the apparent transmittance of the ink. In reflectance, the air gap defocuses the irradiation optics and the imaging optics so that they no longer have the geometric relationship that they did when the instrument was calibrated. These errors are dependent upon the optical properties of the materials involved and any attempt at correction thus becomes a “Catch 22” in which one must correct the property that one is trying to measure using measurements of that property.

What is thus needed in the art is a convenient method of spectroscopy for pigment inks that solves the aforementioned problems of the prior art and avoids the need for such dilutions.

### BRIEF DESCRIPTION OF THE DRAWINGS:

FIG. 1 shows a typical ATR crystal that experiences multiple reflections so as to amplify the level of absorbance;

FIG. 2 shows an ATR crystal according to an exemplary embodiment of the present invention;

FIG. 3 shows reflectance spectra for a variety of printing inks identified by their hue angles (0° being bluish red and stepping through red) (30°, orange) (60°, yellow) (90°, yellow-green) (120°, green) (180°, blue-green) (210°, cyan) (240°, blue) (270°, violet) (300°, purple) (330° and magenta) (360°);

FIG. 4 depict the visible spectra of various dilutions, and areas of those spectra correlated to % determined gravimetrically;

FIG. 5 depicts a side view of an exemplary device for measuring reflectance according to an exemplary embodiment of the present invention;

FIG. 5A depicts the exemplary device of FIG. 5 with additional detail.

FIG. 6 depicts detail of an exemplary lens assembly for the exemplary device of FIG. 5;

FIG. 7 depicts detail of an exemplary focus cup of the exemplary lens assembly of FIG. 6;

FIG. 8 depicts an exemplary prism for the exemplary device of FIG. 5 according to an exemplary embodiment of the present invention;

FIG. 9 is a schematic of an exemplary visible light spectroscopy system according to exemplary embodiments of the present invention;

FIG. 10 is a schematic of an alternate exemplary visible light spectroscopy system according to exemplary embodiments of the present invention; and

FIG. 11 depicts a schematic of another alternate exemplary visible light spectroscopy system according to exemplary embodiments of the present invention.

### SUMMARY OF THE INVENTION

A spectroanalytical system and process for analyzing the absorption properties of viscous, highly absorbing materials is disclosed. The measurement probe includes UV-VIS optical system to deliver incident optical irradiation to a single crystal. The crystal has a shape such that the light impinges on the crystal perpendicular to a surface of the face of the crystal and is incident on the back face at an angle of 45° or greater and the reflected light is collected and channeled to a detector system. This system further provides an attenuated total reflectance (ATR) measurement with minimal reflection points, at least one reflection but not more than three so that the total path length is close to that of a typically printed offset ink film, which ranges between 0.7 micron (10⁻⁶ meter) and 1.3 micron. Thus the total path length of the absorption process is modulated only by the refractive index of the chosen crystal, the refractive index of the material, and the angle of incidence of the single reflection. For high refractive index materials, such as diamond, this process can provide path lengths as short as 50 nm. In exemplary embodiments of the present invention an economical high refractive index material such as cubic zirconium can be used, which can provide a path length as short as 0.1 micron (100 nm).

### DETAILED DESCRIPTION OF THE INVENTION

Exemplary embodiments of the present invention facilitate the analysis of the absorption properties and color strength of an ink or flush without dilution of a sample of such ink or flush. While some organizations, such as, for example, the Quebec Graphics Institute (“QCI”) have been attempting to develop correlative methods using mid-IR processes, including FTIR ATR using a diamond cell, the disclosed method measures visible light absorption directly. This is because there are various drawbacks to the QCI approach. For example, the interaction of the pigment with other components in the ink can affect the pigment's absorption band intensity and position. Additionally, when the pigment's chromophore concentration is measured via infrared, the measurement is actually attributable to molecular vibrations, which may not represent the absorption processes active in the visible spectral region that give rise to the ink's strength of color development. Thus, two inks may have identical IR analysis results, but different visible spectrum absorbance, rendering such correlative methods inexact.

In exemplary embodiments of the present invention, the disclosed measurement procedure can be standardized. This improves both inter-site and supplier to customer agreement on the color strength of inks. This is especially important, for example, for paste inks where suppliers and others in the industry have experienced a great deal of difficulty with the reproducibility of the conventional dilution methods, as they require analytical care in the preparation of test specimens produced from chemically incompatible materials and the personnel in the field are pressmen and machine operators, and not chemical analysts. Using various methods according to exemplary embodiments of the present invention, spectroanalytical systems can be developed for use in the (i) ink/printing, (ii) organic pigments and (iii) flushes and paint/coating, industries.

Such standardization obviates operator dependent errors, as well as context dependent measurement variation (due to air gaps between a measuring device and a given wet sample, for example).

Methods according to exemplary embodiments of the present invention have several unique features. (1) They do not require manual dilution of inks or dispersions with incompatible resins/oils; (2) they do not require making diffuse reflectance measurements of wet inks; (3) the method is easily adapted to online or inline process analytic applications in which the readings are taken during the production of ink dispersions by extracting only a tiny aliquot of material from the process containment vessel or by mounting the crystal into the wall of the containment vessel. In such an adaptation, the dispersion process, which often takes hours to complete, would not have to be stopped to determine if the process had reached completion. (4) The exemplary methods can be implemented using light emitting diodes (LED) or laser diodes as spectral sources. This is because all inks fall broadly into “cyan”, “magenta”, “yellow”, and “black” classifications, and absorbance will occur for lights with colors (red, green, blue, green) respectively; and (5) the measurement system utilizes a hard, single crystal and thus can be easily cleaned and reused, in contrast to present transmission or reflection cells that are single use and must be replaced prior to each use. Given these unique features, systems and methods according to the present invention can effectively avoid all of the sample preparation errors described above.

In exemplary embodiments of the present invention, the assessment of the absolute spectral absorbance of highly absorbing materials such as, for example, printing inks, pigment flushes or concentrated paints, can be accomplished without the need to dilute the material as is required by high accuracy UV-VIS absorption spectroscopy.

Such exemplary methods utilize a measurement system based on a single optical crystal that is produced from a material with a high refractive index such as, for example, sapphire (aluminum oxide), zirconium oxide (commonly known as “cubic zirconium” or “zirconium”), or diamond. The material to be characterized need only be dropped onto the surface of such an exemplary crystal, otherwise requiring no specimen preparation. Alternatively, such a crystal can be inserted onto or into a container of the material to be analyzed. In such a setup the optical fibers would need to be inside of hardened sheaths so that they would not be affected by the process chemicals. Spectral absorbance is measured directly from the thin layer of dispersion covering the surface of the base of the crystal and process parameters such as color strength can be computed from the ratio of the absorbance of a standard ink to that of the ink then being tested. The incident UV-VIS optical radiation can be monochromatic (a narrow band of wavelengths), polychromatic (generated by, for example, a tungsten or xenon lamp) or pseudo-monochromatic (such as is produced by, for example, a light emitting diode or “LED”).

In exemplary embodiments of the present invention, an optical head can either be made very small and thus portable, or can be fashioned larger and thus easier to clean, in a table-top format. Sources and detectors can be coupled to the crystal by an optical system such as, for example, a catoptric, a dioptric or catadioptric imaging system. Optical fibers can be connected using a UV-activated optical cement having a refractive index midway between that of the optical fiber and that of the crystal, so as to minimize interfacial light losses. In exemplary embodiments of the present invention the output of an exemplary electro-optical detection system can be interfaced to a microcomputer which can, for example, convert the raw electrical signals to absorbance and process variables such as color strength using the ratio of absorbances following formulas well known and used in the coloration industry for more than 50 years.

Conventional attenuated total reflection (ATR) spectroscopy is a widely known and utilized technique in the mid-infrared. It is most often used with Fourier transform infrared (FTIR) spectrometers. The principles of ATR spectroscopy are well documented (see Willard, Merritt and Dean, Instrumental Methods of Analysis) and such methods generally require the use of a high refractive index crystal (normally a trapezoidal shape) upon which the specimen is placed. Radiation from a source incident on the first face of the crystal strikes the top face and reflects down to the bottom face; these reflections repeat until the incident radiation reaches the last face and exits the crystal. In this process the incident radiation enters the specimen only slightly as the light waves are bent or reflected back into the crystal instead of being refracted out due to the refractive index difference at which the radiation is specularly reflected back into the crystal instead of being transmitted out. The angle of incidence at which this effect begins to occur is known as the critical angle. The critical angle can be computed directly from the real part of the refractive index of the crystal and the material under test as shown in the following equations.

### Equations for ATR Spectroscopy

The following equations express key relationships for the ATR spectroscopic process, and can thus be used to obtain the total absorbance for a given wavelength. In particular, the following equations describe the relationship between the transmission of light from an ATR crystal and the UV-VIS molecular absorbance of the material under test.

The surface of the material to be measured is pressed into intimate optical contact with the top surface of the crystal. The IR radiation from the spectrometer enters the crystal, and is then reflected through the crystal and penetrates “into” the sample a finite amount with each reflection along the top surface via a so-called “evanescent” wave. At the output end of the crystal, the beam is directed out of the crystal and back into the normal beam path of the spectrometer.

To obtain internal reflectance, the angle of incidence must exceed the so-called ‘critical’ angle θ_{c}. This angle is a function of the real parts of the refractive indices of both the sample and the ATR crystal:

$${θ}_{c} = {sin}^{- 1} ( \frac{{n}_{2}}{{n}_{1}} ) \qquad ( Eq . 1 )$$

Where n₁ is the refractive index of the crystal and n₂ is the refractive index of the material under test. Given that all organic resins will have a refractive index of between 1.48 and 1.52, if a crystal is chosen with an index of refraction near to 2.2, a θ_{c} between 42° & 44° will be obtained.

When reflected the radiation does not bounce back like a billiard ball, but rather an evanescent wave is formed in the material just outside of the crystal, usually extending only a few microns deep. This depth, d, can be computed using Equation 2, where λ is the wavelength of the incident optical radiations and θ is the angle of incidence of such radiation. The depth of penetration of the evanescent wave d is defined as the distance form the crystal-sample interface where the intensity of the evanescent decays to 1/e (37%) of its original value.

$$d = \frac{λ}{\{ 2 π {{n}_{1} [ {sin}^{2} ( θ ) - {( \frac{{n}_{2}}{{n}_{1}} )}^{2} ]}^{\frac{1}{2}} \}} \qquad ( Eq . 2 )$$

Finally, the total absorbance A(λ), as a function of the angle of incidence θ, is given by Equation 3.

$$A ( λ ) = a ( λ ) \cdot c \cdot {b}_{eff} ( λ , {n}_{p} , {n}_{s} , θ , s , p ) \\ {b}_{eff , p} = \frac{{n}_{sp} \cdot λ \cdot cos ( θ )}{π \cdot {n}_{p} \cdot {( 1 - {n}_{sp} )}^{2} \cdot \sqrt{( {sin}^{2} ( θ ) - {n}_{sp}^{2} )}} \\ {b}_{eff , s} = \frac{2 \cdot {sin}^{2} ( θ ) - {n}_{sp}^{2}}{( 1 + {n}_{sp}^{2} ) \cdot {sin}^{2} ( θ ) - {n}_{sp}^{2}} \qquad ( Eq . 3 )$$

Where λ is the wavelength of the optical radiations, θ is the angle of incidence, c is the concentration of absorbers, n is the refractive index for perpendicular (p) polarization, parallel (s) polarization or the average (sp) polarization states, as the case may be.

Equation 3 is based on the Beer-Lambert law of spectroscopy, which states that a measured absorbance (A) is proportional to the absorptivity (a), the concentration of absorbers (c) and the light path length (b). In the case of ATR there is no actual path length so b_{eff} is the effective distance the light travels through the ink.

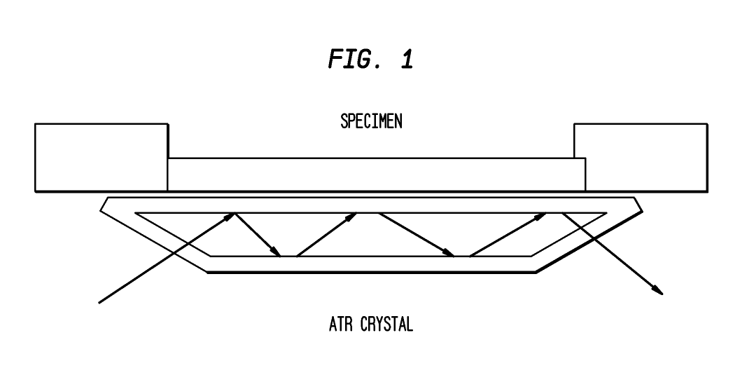

FIG. 1 shows an optical path in traditional ATR spectroscopy with the incident radiation flowing into the crystal on the left and out of the crystal on the right. The multiple bounces through the ATR crystal create multiple instances of the evanescent wave. As a result, the absorption sums as if the path length through the material was much longer than the depth of the individual evanescent wave. However, a strongly absorbing material would still be strongly absorbing after the multiple internal reflections. For example, suppose one has a material that absorbs 90% of the light at each reflection. After the first reflection the light signal is 10% of the original, after the second reflection the light is 1% of the original, and after the third reflection it is 0.1%. So after three bounces there is no more light signal. Similarly, in a conventional transmission cell with a 1 mm path length (1000 micron), the light beam passes into the cell but nothing comes out—as the ink, for example, is highly absorbing.

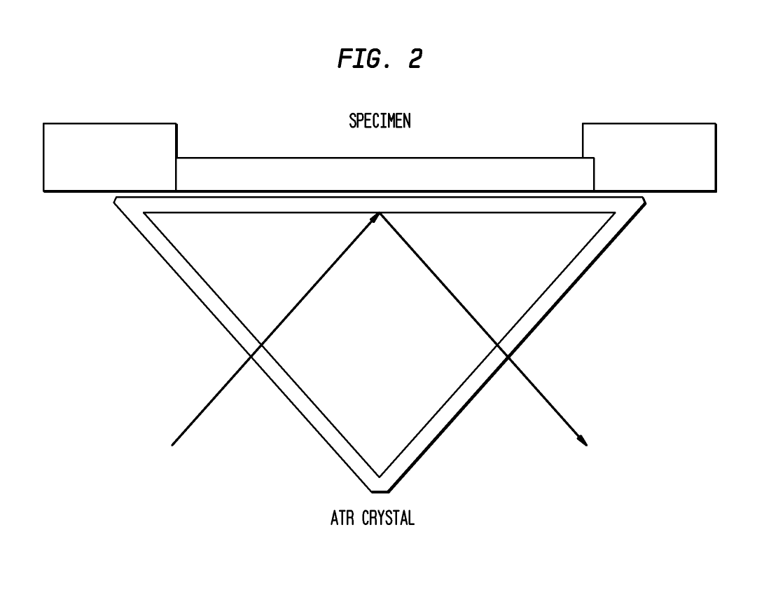

Solving this problem, in exemplary embodiments of the present invention the path length through an ATR crystal can be shortened by changing the shape of the crystal, and minimizing the number of reflections thereby. Thus, for example, FIG. 2 shows the same measurement situation as is depicted in FIG. 1 except that in the setup of FIG. 2 the ATR crystal now has, for example, a tetrahedral or triangular prism shape, which allows for only one point of reflection; this minimizes the distance that the optical radiation passes through the material being tested (which material is in intimate contact with the sample surface of the ATR crystal (in FIG. 2 the sample surface is the upper surface, as can readily be seen).

As noted above, in conventional methods for assessment of the color strength of a pigment, a dispersion of pigments, a paint, an ink or a dyestuff, the highly absorbing colorant (pigment or dye) is diluted with a clear varnish or resin, or with a dispersion of clear varnish containing a white pigment (sometimes called a bleach). This process is required in order to reduce the amount of absorbance to a level where the laws of spectroscopy, generally known as the Beer-Lambert law, will be valid. As is known, the total absorbance should be near 1.0 absorbance unit (or less) for the linear equations relating absorbance to concentration or path length to be valid.

By controlling the effective path length through the ink/pigment/etc. sample, the absorbance can thus be kept below 1.0 au, and thus the absorbance will be in the linear range of the detector or measurement system, thus obviating the need for dilution. It is noted that minimally to moderately diluted inks and pigments can also be measured using the systems and methods of the present invention, and if the dilution is such that the diluent is a small portion of the ultimate solution (such as, for example, 10-30%), some of the problems associated with control and consistency can be managed. It is noted that better results are generally obtained if dilution of the ink or pigment is done using the same vehicle already present in the ink or pigment, rather than using a diluent such as bleach, for example.

In exemplary embodiments of the present invention the effective path length can be controlled by refractive index of the crystal and the angle of incidence into the crystal.

Currently commercially available ATR sample cells, such as, for example, those sold by Axiom, utilize either quartz, which has a low refractive index (1.48) or sapphire (aluminum oxide) which has a medium refractive index (1.78). The most efficient cells are made from diamond which has a refractive index of 2.42, but diamonds are expensive and difficult to machine into the required shapes. Given the equations presented above, it can be seen that the refractive index, n₂, of the crystal controls the minimum angle of use and the depth into the material to be measured that an evanescent wave propagates.

Thus, in exemplary embodiments of the present invention a crystal made of cubic zirconium, the cubic crystal form of zirconium dioxide, can be used. Cubic zirconium has a high refractive index (2.19) and can be prepared synthetically in perfect crystals. Diamonds, being a naturally occurring mineral that are mined and polished, always have internal defects in their crystalline structure. These defects are not critical for the long wavelengths of mid-infrared but will create distortions in the incident and/or reflected light beams within the crystal. In contrast, the use of flawless zirconium crystals will not distort the light beams, which will maximize the signal to noise ratio of the spectroanalytical system. Additionally, cubic zirconium provides many of the advantages of diamond, such as a very hard surface and ease of cleaning, because zirconium also has a high hardness level (8.5 Mohs versus 10 Mohs for a diamond). At the same time, zirconium, being a synthetically produced crystal, is significantly less expensive than diamond.

In exemplary embodiments of the present invention, the ATR crystal can be attached to a traditional UV-VIS analytical spectrometer. In such a configuration, the instrument's light source can be imaged into a monochromator and the monochromatic (narrow band of wavelengths) light can then, for example, be imaged into an optical system that directs the optical radiation onto the face of the crystal adjacent to the specimen. The light that is totally internally reflected within the crystal is collected by the receiving optical system and directed onto the photodetector, for example, a silicon photodiode. Or, for example, it is also possible to image a polychromatic (“white”) source onto the optical input system and then direct the light from the collection optical system into a diode array spectrograph. Such diode array spectrographs are very common in process analytic chemistry and can be obtained very economically. Examples of such devices are, for example, the Ocean Optics USB2000, StellarNet EPP2000, and the Thorlabs CCS100.

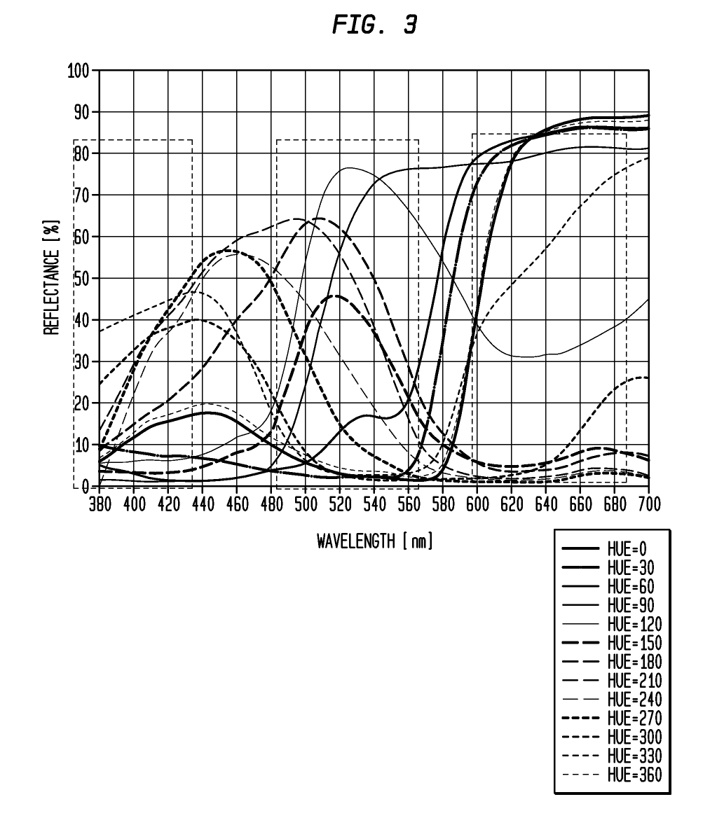

In exemplary embodiments of the present invention, where a crystal has an inherent chromatic dispersion (e.g., cubic zirconium), the illumination and collection optical systems can be designed to compensate for the chromatic dispersion of the crystal by utilizing combinations of mirrors and lenses to correct the chromatic focus shift, in which “blue” light is focused in front of the collection optics and “red” light is focused behind the collection optics. In addition, pigments and dyes in the visible spectral region have very broad and similar absorbance curves, as shown in FIG. 3.

In exemplary embodiments of the present invention, because one cannot generally purchase a VIS only spectrometer, the narrowest range commonly available is UV/VIS. Such a device can be used to take measurements in the visible spectrum. Thus, common sources can have some UV radiance, but not much and the spectrometer will diffract and image light from about 250 nm to 900 nm which is a bit larger range than just that of visible light.

As is shown in FIG. 3, these absorbance curves can be classified into broad categories, based on the region of the spectrum in which the absorbance is at a maximum. Such categories can be the ranges of wavelengths in (i) 380 to 450 nm, (ii) 500 nm to 580 nm, and (iii) 610 nm to 700 nm, for example. Blue and blue-green colorants will have their maximum absorbance in the 610 nm to 700 nm region, violet and magenta colorants will have their maximum absorbance in the 500 nm to 580 nm region, and yellow-green and yellow colorants will have a maximum in the 380 nm to 450 nm region.

The classifications shown in FIG. 3 can be utilized to check for the correct reflectance/absorbance properties—and thus the correct and desired color—in pigments, dispersions, flushes, inks and paints in exemplary embodiments of the present invention. This is because generally a pigment, dispersion, flush, ink or paint has a certain spectroscopic profile within its particular color. The correct profile is known, and one tests sample compositions to see if they match the correct profile. Thus, for example, as noted, a blue or blue-green pigment will have maximum absorbance in the 610 to 700 nm range (the third wavelength category of FIG. 3). Thus it can in some contexts be of little concern how it absorbs in the other wavelength bands, i.e., the 380-450 nm or 500-580 nm ranges, such as when testing for the correct pigment composition. (It can be of significant concern when testing a sample material for contaminants, however). Thus, one can test for the correct spectroscopic profile of the pigment by using incident light in a narrow wavelength band, and test the absorbance only in that key wavelength band. In the exemplary case of a blue or blue green pigment, dispersion, flush or paint, a narrow band of wavelengths in the 610 to 700 nm range is all that is needed. This can be supplied by an LED, for example, whose emitted light is centered at 650 nm.

Thus, in exemplary embodiments of the present invention a compact device can be produced using three LED or laser diode light sources, with emissions near to 430 nm, 530 nm and 650 nm, respectively (i.e., at the approximate centers of the three respective wavelength bands shown in FIG. 3). It is noted that no fiber may be needed if the LED or laser diode is imaged directly onto the detector. The compact device can be constructed such that the LED can be easily switched out, and thus the device can be supplied with three LEDs which can be switched in and out as appropriate. Or, for example, in a more complex arrangement, all three LEDs can be provided in a device, and the user can select which one provides the incident light to the crystal.

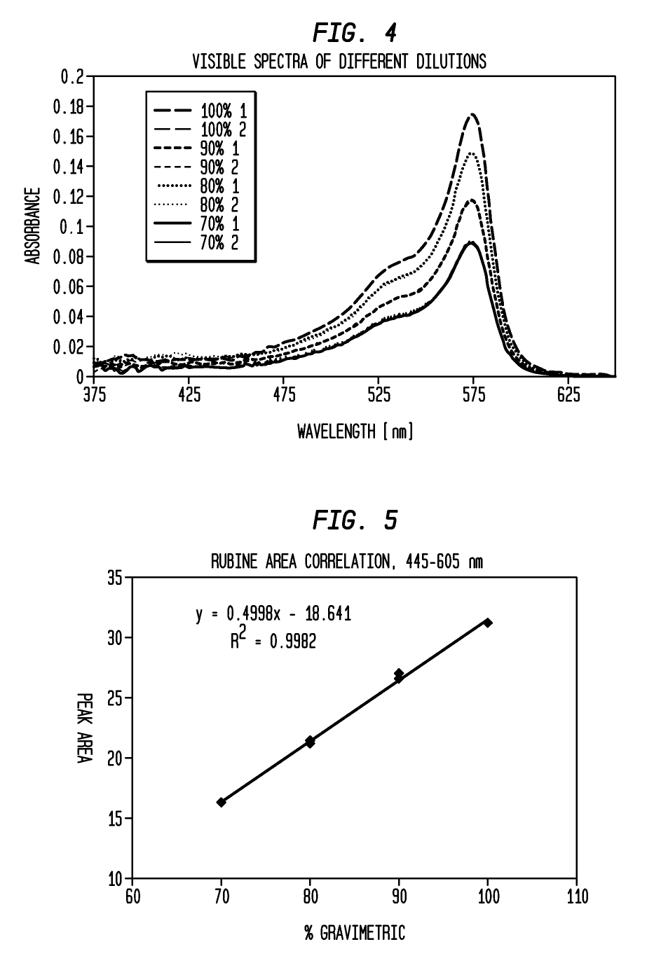

FIG. 4 depict results from a series of readings of Rubine magenta pigment (upper panel) and the plot of actual concentration versus absorbance (lower panel) showing a very strong linear relationship. From these graphs can be seen the fact that two samples can be accurately matched for pigment absorbance, and that the percentage pigment can be determined by correlation to known samples.

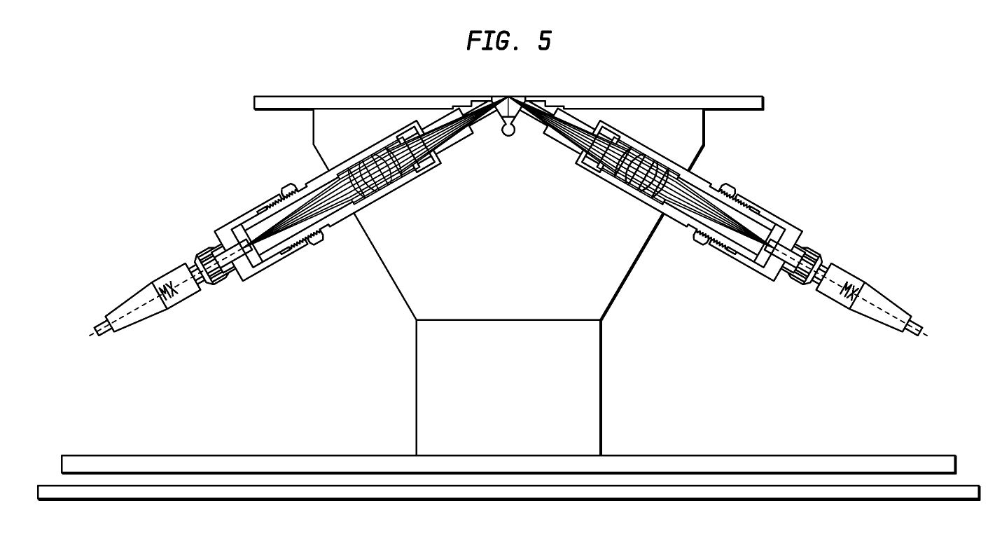

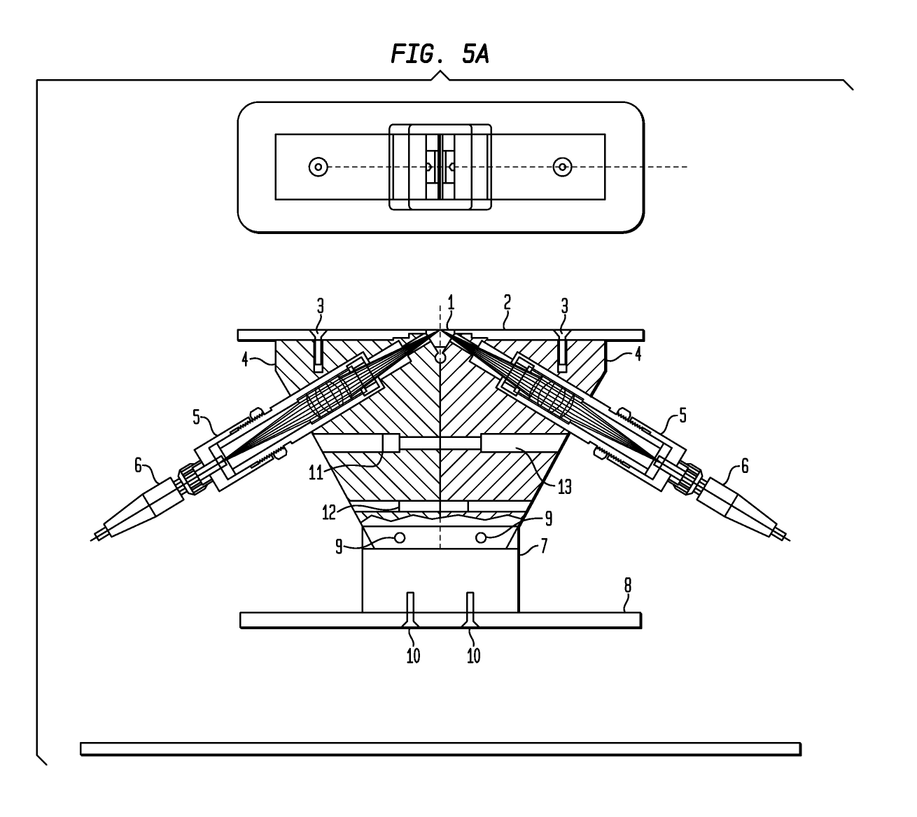

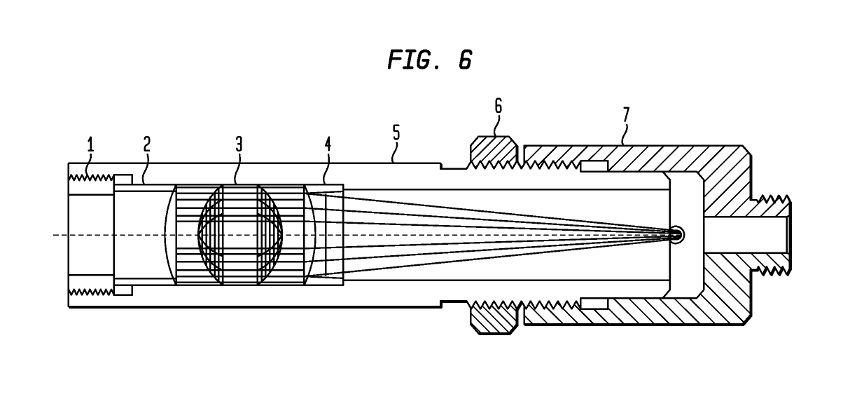

FIG. 5 is a schematic drawing of an exemplary ATR test setup according to an exemplary embodiment of the present invention. FIG. 5A depicts the same device with additional details, and also depicts a top view of the device (upper panel). With reference thereto, there is, on each of the input and output channels (left and right, respectively) an optical connector 6 connected to a lens assembly 5 (detail of which is depicted in FIG. 6). The light passes through the lens assembly to the crystal 1, provided in a top 2. The top is fastened to an optical base 4, by means of screws 3, and optical base 4 is held by clamp 7, via fasteners 9. Clamp 7 is fastened to base 9 by means of screws or other fasteners 10. There is also provided an alignment nut 11 and dowel pin 12.

FIG. 6 depicts detail of an exemplary lens assembly for the exemplary device of FIG. 5. With reference thereto, said lens assembly has a retainer 1, a spacer 2, a lens triplet 3, a spacer 4, a lock nut 6 and a focus cup 7. Lock nut 6 holds lens cell 5 securely within focus cup 7.

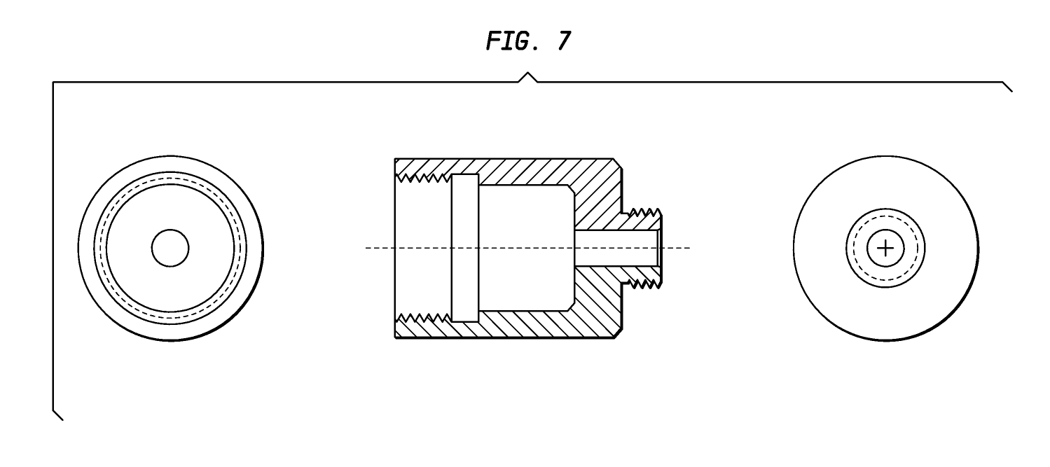

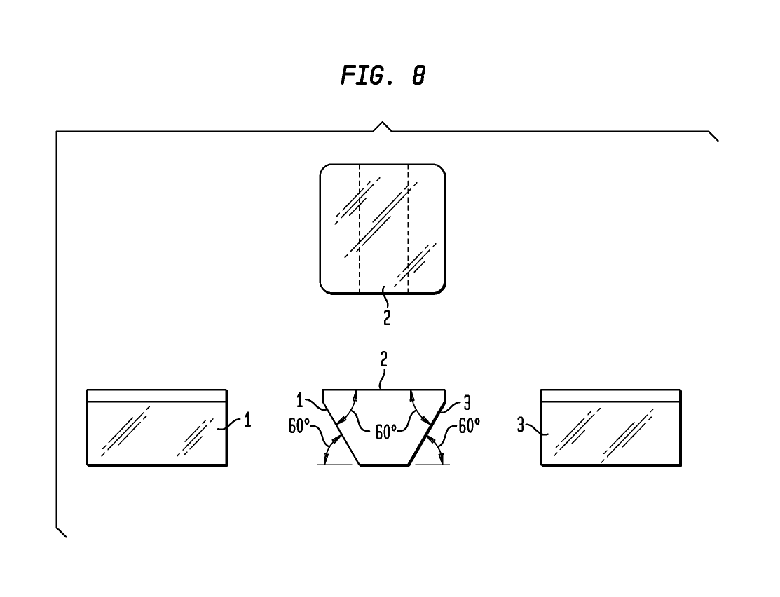

FIG. 7 depicts detail of an exemplary focus cup 7 of the exemplary lens assembly of FIG. 6, and FIG. 8 depicts an exemplary prism for the exemplary device of FIG. 5. With reference to FIG. 8, there are side faces of the crystal 1 and 3, as well as top surface 2. FIG. 8 depicts the exemplary crystal in side (center) as well as side-facing (right and left) and top-facing (above) views.

With reference again to FIG. 5A, the largest pieces shown in FIG. 5A are solid blocks of aluminum used to provide strength to the system, to provide a protected mount for the ATR crystal and to provide pathways for the incident and reflected light to pass to and from the crystal. In this figure, light is carried to crystal by an optical fiber 6 that is terminated with a standard SMC connector. Component 5 contains a custom lens assembly that collects the light emitted from the fiber coming from the source and collimates, the beam, then projects that circular image onto the base of the crystal. This forms an ellipse on the inside surface of the base of the crystal. That elliptical image is collected by the receiving optics and refocused onto the entrance to the second optical fiber which carries the reflected light to the spectrometer. The custom optics are designed so that the beam traverses the face of the crystal along the perpendicular and is approximately collimated. The combination of orthogonal transaction and near collimation reduces the effect of the high dispersion of the zirconium crystal and thus avoids the use of a catadioptric system of mirrors and lenses to compensate for the chromatic dispersion of the image.

The exemplary components in FIGS. 5-8 are for illustration only, and are solely exemplary in nature. They represent one of many possible embodiments of an exemplary test apparatus according to the present invention, and are not at all to be considered or construed as limiting. Persons skilled in the art will understand that various alternate apparati can be fashioned to implement exemplary embodiments of the present invention.

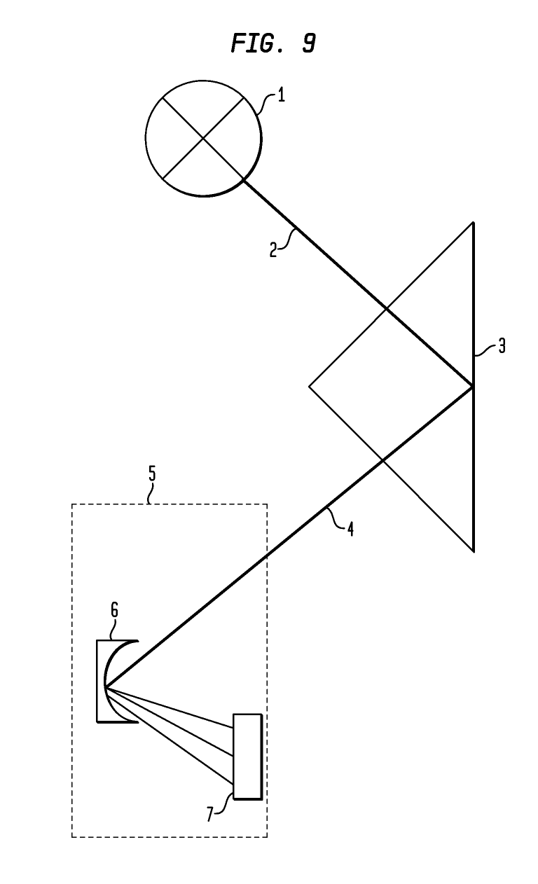

FIGS. 9-11 schematically depict three exemplary visible light spectroscopy systems according to exemplary embodiments of the present invention.

With reference to FIG. 9, there is shown in a preferred embodiment a light source 1, which generates incident light rays 2. The incident light rays enter crystal 3, where they are reflected once, and an evanescent wave thus enters a sample (not shown) placed on top of crystal 3. Exiting crystal 3 are reflected light rays 4, which are then input to a spectrometer 5. The spectrometer 5 comprises a diffraction grating 6, which separates the light rays and projects them onto a diode or CCD sensor array 7 for detection.

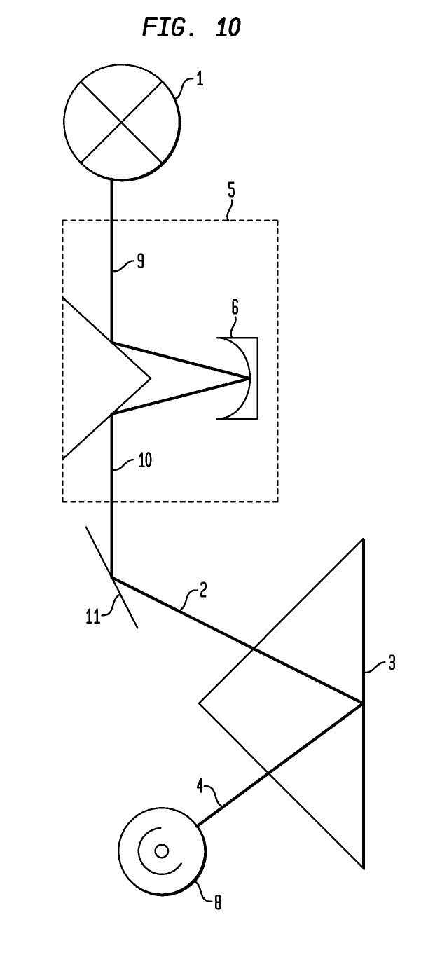

FIG. 10 depicts an alternate embodiment of a light spectroscopy system according to an exemplary embodiment of the present invention. Although similar to the exemplary system of FIG. 9, this alternate exemplary system has a photodetector 8 to measure the light leaving the crystal 3. Additionally, the light from light source 1 is polychromatic, but is then directed to a monochromator, such as a grating monochromator, 6, from which monochromatic light 10 emerges. This monochromatic light 10 is reflected by a steering mirror onto the crystal 3. This alternate embodiment allows a user) to test the absorbance at a series of different single wavelengths and thus generate a set of absorbance values, rather than scanning the entire spectrum.

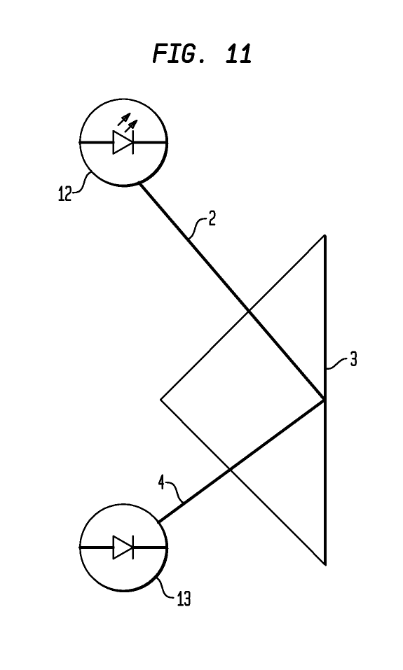

Finally, FIG. 11 depicts an exemplary embodiment using an LED 12 as a light source and a photodiode 13 as a detector. The LED may be a continuous “white” based on a blue diode and a yellow phosphor or it may be a tri-color or RGB-LED where the single LED source contains three (3) miniature LED chips, a short wavelength (“blue”) LED, a medium wavelength (“green”) LED and a long wavelength (“red”) LED. The tri-color LED may be driven with one chip excited at a time, producing light with the appearance of only that single color or it may be driven with all three LEDs emitting their band of wavelengths producing a sort of white appearance. The small LED lamp is mounted in place of the optical fiber with suitable baffles to simulate the emission from the optical fiber end surface. At the other side of the instrument, the optical fiber is replaced with a simple photodiode whose spectral responsivity is matched to the emission of the LEDs. This eliminates all of the external optics and makes the instrument more compact and robust. The cost of the LED and photodiode and required circuitry will be at least 200 times less expensive than a continuous light source, optical fibers and spectrometer system.

It will thus be seen that the objects set forth above, among those made apparent from the preceding description, are efficiently attained, and since certain changes may be made in the above processes and constructions without departing from the spirit and scope of the invention, it is intended that all matter contained in the above description or shown in the accompanying drawings shall be interpreted as exemplary and illustrative and not as limiting.

It is also to be understood that the following claims are intended to cover all of the generic and specific features of the invention herein described and all statements of the scope of the invention which, as a matter of language, might be said to fall there between.

What is claimed:

1. An attenuated total reflectance (ATR) spectroanalytical system for assessing the absorbance of a light absorbing material, comprising:
a crystal, said crystal having a geometry such that the absorbance of a material placed upon the crystal is within the linear range of the detector;
an input channel and an output channel;
an incident light source; and
a detector.

2. The system of claim 1 wherein the crystal is composed of one of cubic zirconium, diamond and sapphire.

3. The system of claim 1, wherein the incident light source is arranged to direct incident light to a face of the crystal at a defined angle of incidence.

4. The system of claim 3, wherein said defined angle of incidence is approximately 60 degrees.

5. The system of claim 3, wherein said defined angle of incidence is greater than 45 degrees.

6. The system of claim 3, wherein the geometry of the crystal and the defined angle of incidence is such that there is only one reflection of an incident ray.

7. The system of claim 1, wherein the crystal has one of a trapezoidal and pyramidal shape.

8. The system of claim 1, wherein the geometry and composition of the crystal are chosen such that a total path length of an evanescent wave into the sample is less than 1 micrometer.

9. The system of claim 1, wherein the incident light source is one of a scanning monochromator, a laser diode, and an continuous wave lamp, such as an incandescent lamp, a discharge lamp or a flash lamp.

10. The system of claim 1 in which the detector is one of a silicon photodiode detector, a gallium phosphide or gallium arsenide phosphide visible photodiode detector, a photomultiplier detector, and a grating or prism spectrograph with a diode or CCD array detector.

11. The system of claim 1, wherein the photodetector is connected to the analog to digital converter, and wherein said analog to digital converter is arranged to convert the analog electrical signals from the photodetector into a digital signal compatible with a digital microprocessor or personal computer.

12. The system of claim 1, wherein the incident light source is at least one LED.

13. The system of claim 12, wherein the incident light source is a set of at least three LEDs.

14. The system of claim 13, wherein the three LEDs have their emissions substantially centered at 430 nm, 530 nm and 650 nm, respectively.

15. The system of claim 13, wherein only one LED can be used at a time, and the three LEDs can be easily inserted in and removed from the device.

16. The system of claim 1, wherein the input channel and the output channel are arranged to compensate for any chromatic dispersion of the crystal.

17. The system of claim 16, wherein combinations of mirrors and lenses are used to compensate for said chromatic dispersion.

18. The system of claim 17, wherein “blue” light is focused in front of the collection optics and “red” light is focused behind the collection optics.

19. The system of claim 1, wherein the crystal is easily cleaned and reusable.

20. A method of measuring the absorbance of a light absorbing material comprising:
placing a material directly on a face of an ATR crystal;
irradiating the crystal with light at an angle of incidence, the geometry of the crystal and said angle of incidence chosen such that the absorbance of the material is within the linear range of a detector;
detecting the light output by the ATR crystal; and
determining the absorbance of the material at one or more wavelengths.

21. The method of claim 20, wherein the material is one of undiluted and minimally diluted.

22. The method of claim 20, wherein the crystal is composed of one of cubic zirconium, diamond and sapphire.

23. The method of claim 20, wherein the visible incident light source is arranged to direct incident light to a face of the crystal at a defined angle of incidence.

24. The method of claim 23, wherein said defined angle of incidence is approximately 60 degrees.

25. The method of claim 23, wherein said defined angle of incidence is greater than 45 degrees.

26. The method of claim 23, wherein the geometry of the crystal and the angle of incidence is such that there is only one reflection of an incident ray.

27. The method of claim 20, wherein the crystal has one of a trapezoidal and pyramidal shape.

28. The method of claim 20, wherein the geometry and composition of the crystal are chosen such that a total path length of an evanescent wave into the sample is less than 1 micrometer.

29. The method of claim 20, wherein the visible incident light source is one of a scanning monochromator, a laser diode, and an incandescent lamp.

30. The method of claim 20 in which the photodetector is one of a silicon photodiode detector, a gallium phosphide or gallium arsenide phosphide visible photodiode detector, a photomultiplier detector, and a grating or prism spectrograph with a diode or CCD array detector.

31. The method of claim 20, wherein the photodetector is connected to the analog to digital converter, and wherein said analog to digital converter is arranged to convert the analog electrical signals from the photodetector into a digital signal compatible with a digital microprocessor or personal computer.

32. The method of claim 21, wherein the incident light source is at least one LED.

33. The method of claim 22, wherein the incident light source is a set of three LEDs.

34. The method of claim 33, wherein the three LEDs have their emissions substantially centered at 430 nm, 530 nm and 650 nm, respectively.

35. The method of claim 33, wherein only one LED can be used at a time, and the three LEDs can be easily inserted in and removed from the device.

36. The method of claim 20, wherein input optical channel and the output optical channel are arranged to compensate for any chromatic dispersion of the crystal.

37. The method of claim 36, wherein combinations of mirrors and lenses are used to correct for said chromatic dispersion.

38. The method of claim 37, wherein short wavelength (“blue”) light is focused in front of the collection optics and long wavelength (“red”) light is focused behind the collection optics.

39. The method of claim 20, wherein the crystal is easily cleaned and reusable.

40. The spectroanalytical system of claim 1, wherein the input channel and the output channel are optical.

41. The spectroanalytical system of claim 1, wherein the incident light source outputs visible light.

42. The method of claim 20, wherein the input channel and the output channel are optical.

43. The method of claim 20, wherein the incident light source outputs visible light.

44. An attenuated total reflectance (ATR) spectroanalytical system for assessing the absorbance of a light absorbing material, comprising:
a cubic zirconium crystal, said crystal having a geometry such that the absorbance of a material placed upon the crystal is within the linear range of the detector;
an input channel and an output channel;
an incident light source; and
a detector.

45. The spectroanalytical system of claim 44, wherein the input channel and the output channel are optical.

46. The spectroanalytical system of claim 44, wherein the incident light source outputs visible light.

47. The spectroanalytical system of claim 44, said cubic zirconium crystal having a geometry such that the absorbance a material placed upon the crystal is less than or equal to 1.0 au.

48. A device for assessing the absorbance of a light absorbing material, comprising:
a crystal, said crystal having a geometry such that the absorbance of a material placed upon the crystal is within the linear range of the detector;
an input channel and an output channel;
an incident light source;
a detector; and
an analog to digital converter.

49. The device of claim 48, wherein the input channel and the output channel are optical.

50. The device of claim 48, wherein the incident light source outputs visible light.

51. The system of claim 1, said crystal having a geometry such that absorbance of a material placed upon the crystal is less than or equal to 1.0 au.

52. The method of claim 20, said crystal having a geometry such that the absorbance of a material placed upon the crystal is less than or equal to 1.0 au.
